(19) United States
(12) Patent Application Publication
(10) Pub. No.: US 2012/0098484 A1
(43) Pub. Date: Apr. 26, 2012

(54) Wireless charging system, battery with wireless charging function and electronic devices with the same

(75) Inventors: Holung Cheng, Hong Kong (CN); Shuo Chen, DongGuan (CN); Xiaoqin Deng, DongGuan (CN); Yi Tian, DongGuan (CN); Jinling Luo, DongGuan (CN); Dongqiang Xie, DongGuan (CN)

(73) Assignee: SAE Magnetics (H.K.) Ltd., Hong Kong (CN)

(21) Appl. No.: 12/929,155

(22) Filed: Jan. 4, 2011

(30) Foreign Application Priority Data
Oct. 26, 2010 (CN) 201010539410.5

(51) Int. Cl. H02J 7/00

(52) U.S. Cl. 320/108

(57) ABSTRACT

A battery adapted to a wireless charging system which comprises a coil, a PCB, a core, a shield and a case. The coil is configured to induce the magnetic power transmitted from the transmitter of the wireless charging system to generate inductive current. The PCB is electrically connected the coil to transform the inductive current of the coil into electrical power. The core is electrically connected the PCB to store the electrical power. The shield is sandwiched between the coil and the core to protect the core from magnetic power of the transmitter and enhance inductance of the coil; and the case is configured to enclose the coil, the PCB, the core, and the shield therein. The invention also discloses a wireless charging system with such a battery, a electronic device with wireless charging function.

### FIELD OF THE INVENTION

The present invention relates to wireless charging technology, and more particularly, to a wireless charging system, a new battery with wireless charging function and electronic device with the same.

### BACKGROUND OF THE INVENTION

In the modern age, in which the technology changes with each passing day, humans have used to make their life become more conveniently by widely using various electronic apparatuses. With continued growth in the use of battery-operated portable electronic devices, there are increasing concerns about the problems associated with conventional battery chargers. Battery-operated portable electronic devices are often provided with a battery charger for use in recharging the batteries.

Many conventional battery chargers include a power cord that plugs into a power input port on an electronic device. FIG. 1 illustrates a conventional corded power supply battery charger 100 and shows an electronic device (such as a mobile phone 101) powered by an adapter 102 which directly connects with power supply thru a lot of complicated cords 103. The design of the corded battery charger 100, usually including power specifications and plug configuration, typically varies from device to device such that a battery charger of one device is not likely to operate properly in charging the batteries of another device. Accordingly, a user with multiple electronic devices is required to maintain and store a variety of different battery chargers. In addition, the cords of conventional corded battery chargers are unsightly and have a tendency to become tangled both alone and with cords of other chargers. What's more, corded chargers are also relatively inconvenient because a user is required to plug and unplug the cord each time the device is charged, and huge standby power of adapter is a big waste for energy saving.

To overcome these and other problems associated with corded battery chargers, there is a growing trend toward the use of wireless charging systems for charging batteries in portable electronic devices. Wireless charging technology (WPT) is quite popular and widely applied in the field of electrical and electronic devices, especially for a mobile phone and a laptop. Referring to FIGS. 2-3, FIG. 2 illustrates a conventional wireless charger, FIG. 3 is a block diagram showing the wireless charging module of FIG. 2. For a mobile phone 201 with a battery 210, the current wireless charger 200 use a wireless charging transmitter 202 and a wireless charging receiver 203 to realize wireless charging function, thereof the wireless charging transmitter 202 is used to generate magnetic power and transmit it, and the wireless charging receiver 203 is used to induce the magnetic power transmitted from the wireless charging transmitter 202 to charging power to the battery 210 of the mobile phone 201. The wireless charging receiver 203 is usually connected with the battery 210 of the mobile phone 201 thru a case which includes a wireless charging receiving and conversion circuit.

Now referring to FIGS. 4-6, the conventional battery 210 of electronic devices include a battery case 211, a battery core 212 and a PCB 213 which are attached to the battery case 211. The battery core 212 is configured to store charging power transformed from the wireless charging receiver 203 and supply charging power for electronic devices. The PCB 213 with an battery protection circuit integrated is used to protect the battery 210 during charging and discharging. The battery base 211 is configured to protect and fix all the battery components aforesaid into a solid appearance.

So the conventional wireless charging systems offer a number of advantages. For example, they eliminate the unsightly mess created by a collection of charger cords and eliminate the need for users to plug and unplug the device from the charger.

Although the conventional wireless charging system can be a marked improvement over wired chargers, they continue to suffer from some inconveniences. For example, due to limitations inherent in their nature of battery of some electronic devices, when a electronic device with a battery is charged, the electronic device needs to be electrically connected to the supply power via the wireless charging receiver 203 of the wireless charger 200. Thus, the user cannot operate the wireless electronic device in a wireless manner so that the convenience in using the conventional wireless chargers is low.

Hence, a need has arisen for providing an improved wireless charging system with a battery to solve the above-mentioned problems and achieve a good performance.

### SUMMARY OF THE INVENTION

Accordingly, an object of the present invention is to provide a new battery as a receiver adapted to a wireless charging system with a wireless transmitter, and can be charged by any kind of a wireless transmitter without an extra receiver.

A further object of the present invention is to provide a wireless charging system with a transmitter and a battery as a receiver adapted to the wireless charging system with wireless charging function, and the battery can be charged by any kind of a wireless transmitter without an extra receiver.

Another object of the present invention is to provide a electronic device with a new battery as a receiver adapted to a wireless charging system with a wireless transmitter, and can be charged by any kind of a wireless transmitter without an extra receiver.

Still another object of the present invention is to provide a electronic device having wireless charging function without an extra receiver, and able to be charged by and kind of a wireless power transmitter.

To achieve the above-mentioned objectives, a battery adapted to a wireless charging system which comprises a transmitter for generating and transmitting magnetic power, the battery comprises a coil, a PCB, a core, a shield and a case. The coil is configured to induce the magnetic power transmitted from the transmitter of the wireless charging system to generate inductive current. The PCB is electrically connected the coil to transform the inductive current of the coil into electrical power. The core is electrically connected the PCB to store the electrical power. The shield is sandwiched between the coil and the core to protect the core from magnetic power of the transmitter and enhance inductance of the coil; and the case is configured to enclose the coil, the PCB, the core, and the shield therein.

Preferably, the coil is printed on the PCB by plating, etching or silkscreen processes.

Preferably, the coil is printed on a FPCB by etching or silkscreen processes and then connected with the PCB.

Preferably, the coil is metal magnet wire.

Preferably, the PCB is integrated with a resonant circuit, a rectifying circuit, a charging circuit and a battery protect circuit, the resonant circuit is connected to the coil to transform the inductive current into electrical power; the rectifying circuit serves as receiving and rectifying the electrical power of the resonant circuit; the charging circuit receives the rectified electrical power to charge the battery; and the battery protect circuit protects the battery from overcharge and short.

A wireless charging system, comprises a transmitter and a battery, the transmitter is configured to generate and transmit magnetic power, the battery is configured to induce the magnetic power transmitted from the transmitter and store electric power transformed from the magnetic power. The battery comprises a coil, a PCB, a core, a shield and a case. The coil is configured to induce the magnetic power transmitted from the transmitter of the wireless charging system to generate inductive current. The PCB is electrically connected the coil to transform the inductive current of the coil into electrical power. The core is electrically connected the PCB to store the electrical power. The shield is sandwiched between the coil and the core to protect the core from magnetic power of the transmitter and enhance inductance of the coil; and the case is configured to enclose the coil, the PCB, the core, and the shield therein.

Preferably, the transmitter includes a power supply circuit, a frequency generating circuit, a amplifying circuit and a transmitting resonant circuit, the power supply circuit serves as supplying power source; the frequency generating circuit is used to generate oscillator power; the amplifying circuit serves as receiving and amplifying the oscillator signals of the frequency generating circuit; and the transmitting resonant circuit is connected to a transmitting coil to transform the amplified signals into magnetic power and transmit the magnetic power.

Preferably, the PCB is integrated with a resonant circuit, a rectifying circuit, a charging circuit and a battery protect circuit, the resonant circuit is connected to the coil to transform the inductive current into electrical power; the rectifying circuit serves as receiving and rectifying the electrical power of the resonant circuit; the charging circuit receives the rectified electrical power to charge the battery; and the battery protect circuit protects the battery from overcharge and short.

Preferably, the coil is printed on the PCB by plating, etching or silkscreen process.

Preferably, the coil is printed on a FPCB by etching or silkscreen process and then connected with the PCB.

Preferably, the coil is metal magnet wire.

An electronic device adapted to a wireless charging system, the wireless charging system comprises a transmitter for generating and transmitting magnetic power, the electronic device comprises a housing and a battery configured to be housed in the housing, and the battery comprises a coil, a PCB, a core, a shield and a case. The coil is configured to induce the magnetic power transmitted from the transmitter of the wireless charging system to generate inductive current. The PCB is electrically connected the coil to transform the inductive current of the coil into electrical power. The core is electrically connected the PCB to store the electrical power. The shield is sandwiched between the coil and the core to protect the core from magnetic power of the transmitter and enhance inductance of the coil; and the case is configured to enclose the coil, the PCB, the core, and the shield therein.

Preferably, the coil is printed on the PCB by plating, etching or silkscreen process.

Preferably, the coil is printed on a FPCB by etching or silkscreen process and then connected with the PCB.

Preferably, the coil is metal magnet wire.

Preferably, the PCB is integrated with a resonant circuit, a rectifying circuit, a charging circuit and a battery protect circuit, the resonant circuit is connected to the coil to transform the inductive current into electrical power; the rectifying circuit serves as receiving and rectifying the electrical power of the resonant circuit; the charging circuit receives the rectified electrical power to charge the battery; and the battery protect circuit protects the battery from overcharge and short.

An electronic device adapted to a wireless charging system, the wireless charging system comprising a transmitter for generating and transmitting magnetic power, the electronic device comprising housing and a battery configured to be housed in the housing, wherein the electronic device further comprises a coil and a shield configured to be housed in the housing, the coil is configured to induce the magnetic power transmitted from the transmitter of the wireless charging system to generate inductive current for the battery, and the shield is sandwiched between the coil and the battery to protect the battery from the magnetic power of the transmitter and enhance inductance of the coil.

Preferably, the housing comprises a main frame and a back cover, the battery is attached to the main frame and the back cover is configured to cover the battery.

Preferably, the coil is printed on the back cover by plating, etching or silkscreen process.

Preferably, the coil as an independent coil which is over-molded into the back cover.

According to an example embodiment, the battery comprises a case, a core and a PCB which are attached to the battery case, the PCB is electrically connected to the coil to transform the inductive current of the coil into electrical power for the battery; and the core is electrically connected to the PCB to store the electrical power.

According to another example embodiment, the electronic device further comprises a PCB situated in the front or on the side of the back cover for electrically connecting the coil to transform the inductive current of the coil into electrical power for the battery.

In comparison with the prior art, the present wireless charging system has a new battery which as a receiver adapted to a wireless charging system with a wireless transmitter can be charged by any kind of a wireless transmitter without an extra receiver, thus the present design predigest the system compose greatly and advanced the dependability. What's more, the present invention provides an electronic device adapted to a wireless charging system with a wireless transmitter, the electronic device can be charged by touching or being near to the wireless transmitter of the wireless charging system without a extra receiver, such that can convenient wireless charging manner, enhance the charging efficiency and then save energy.

Other aspects, features, and advantages of this invention will become apparent from the following detailed description when taken in conjunction with the accompanying drawings, which are a part of this disclosure and which illustrate by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional corded power supply battery charger;

FIG. 2 is a perspective view of a conventional wireless charger;

FIG. 3 is a block diagram showing the wireless charging module of FIG. 2;

FIG. 4 is a perspective view of a conventional battery;

FIG. 5 a sectional view of the conventional battery shown in FIG. 4 taking along line A-A;

FIG. 6 is a exploded, perspective view of the conventional battery shown in FIG. 4;

FIG. 7 is a perspective view of a first embodiment of a wireless charging system according to the present invention;

FIG. 8 is a block diagram showing the transmitter of a wireless charging system according to the first embodiment of the present invention;

FIG. 9 is a detailed circuit of the block diagram of the transmitter shown in FIG. 8;

FIG. 10 is a block diagram showing the electronic device as a receiver of a wireless charging system according to the first embodiment of the present invention;

FIG. 11 is a detailed circuit of the block diagram of the electronic device as a receiver shown in FIG. 10;

FIG. 12 is a exploded, perspective view of a electronic device according to a first embodiment of the present invention;

FIG. 13 is a perspective view of the battery of the electronic device shown in FIG. 12;

FIG. 14 a sectional view of the battery shown in FIG. 13 taking along line B-B;

FIG. 15 is a exploded, perspective view of the battery shown in FIG. 13;

FIG. 16 is a perspective view of the battery of the electronic device according to a second embodiment of the present invention.

FIG. 17 a sectional view of the battery shown in FIG. 16 taking along line C-C;

FIG. 18 is a exploded, perspective view of the battery shown in FIG. 16;

FIG. 19 is a exploded, perspective view of a electronic device according to a second embodiment of the present invention;

FIG. 20 is a perspective view of the battery of the electronic device shown in FIG. 19;

FIG. 21 is a exploded, perspective view of a electronic device according to a third embodiment of the present invention;

FIG. 22 is a exploded, perspective view of a electronic device according to a fourth embodiment of the present invention.

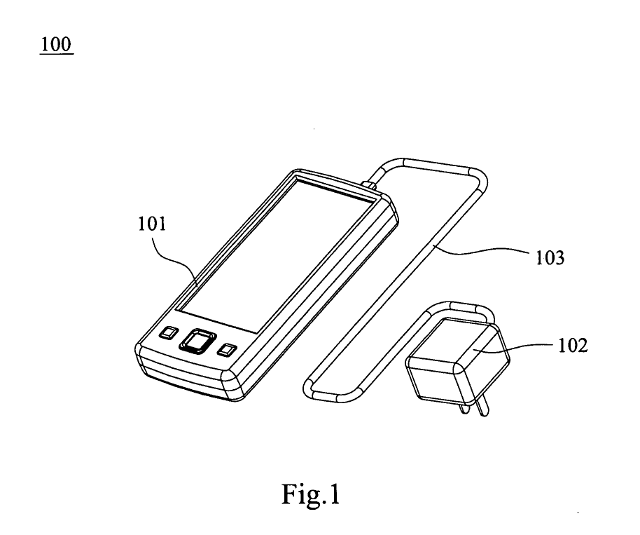

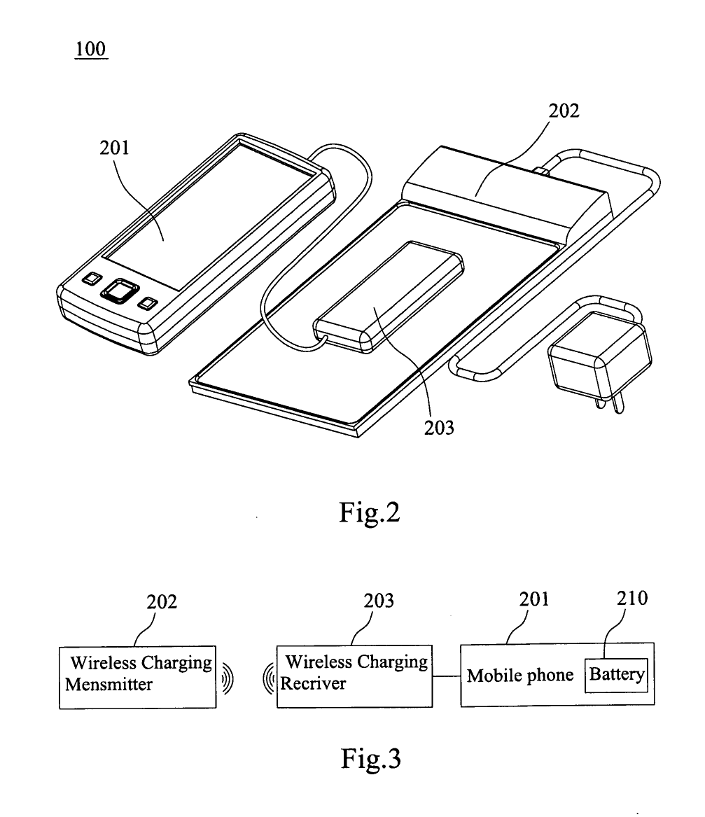

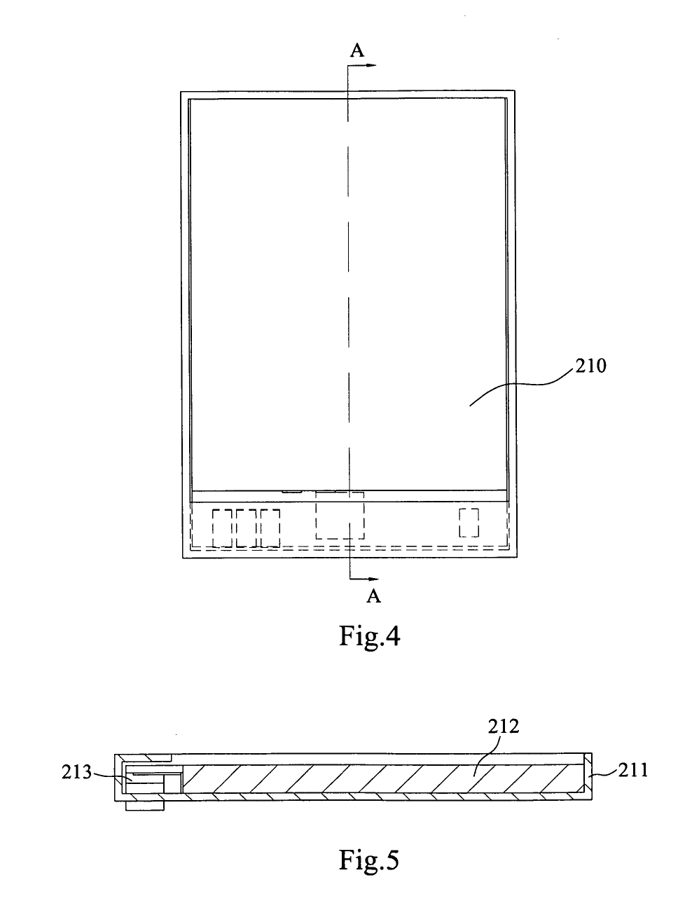

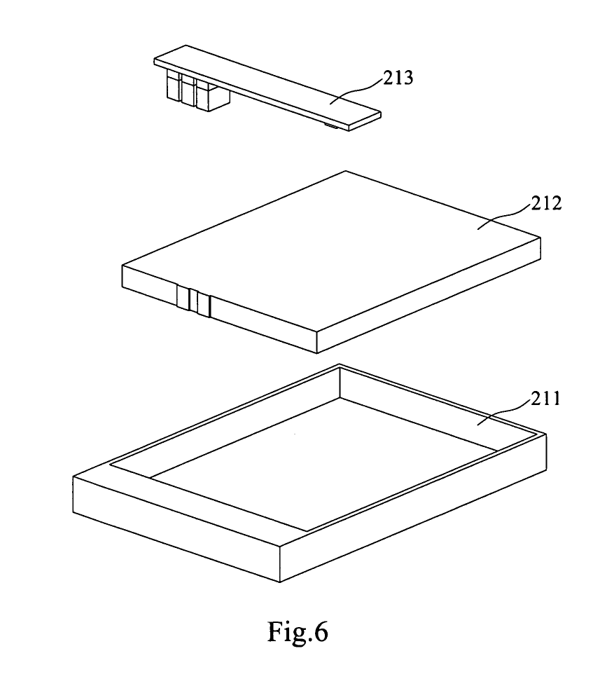

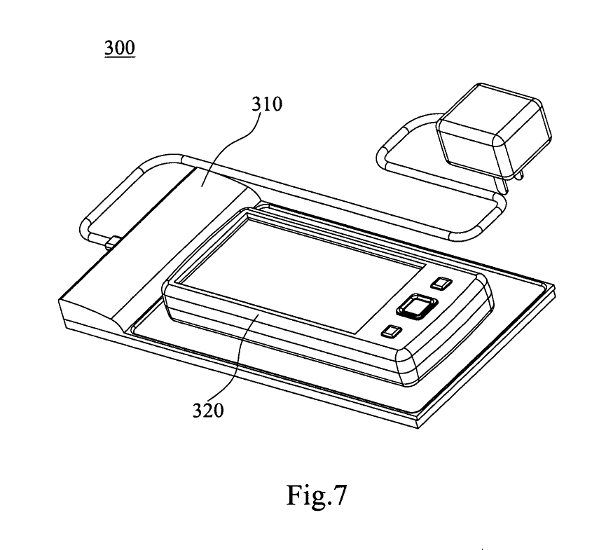

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a wireless charging system has a new battery which as a receiver adapted to a wireless charging system with a wireless transmitter can be charged by any kind of a wireless transmitter without an extra receiver, thus the present design predigest the system compose greatly and advanced the dependability.

Referring to FIG. 7, FIG. 7 is a perspective view of a first embodiment of a wireless charging system 300 according to the present invention. The wireless charging system 300 includes a transmitter 310 and a electronic device 320 as a receiver to realize wireless charging function, thereof the transmitter 310 is used to generate magnetic power and transmit it, and the electronic device 320 is used to induce the magnetic power transmitted from the transmitter 310 and store electric power transformed from the magnetic power. The electronic device 320 can be charged by near or on the transmitter 310, so it doesn't need to be electrically connected to an extra receiver to realize wireless charging function.

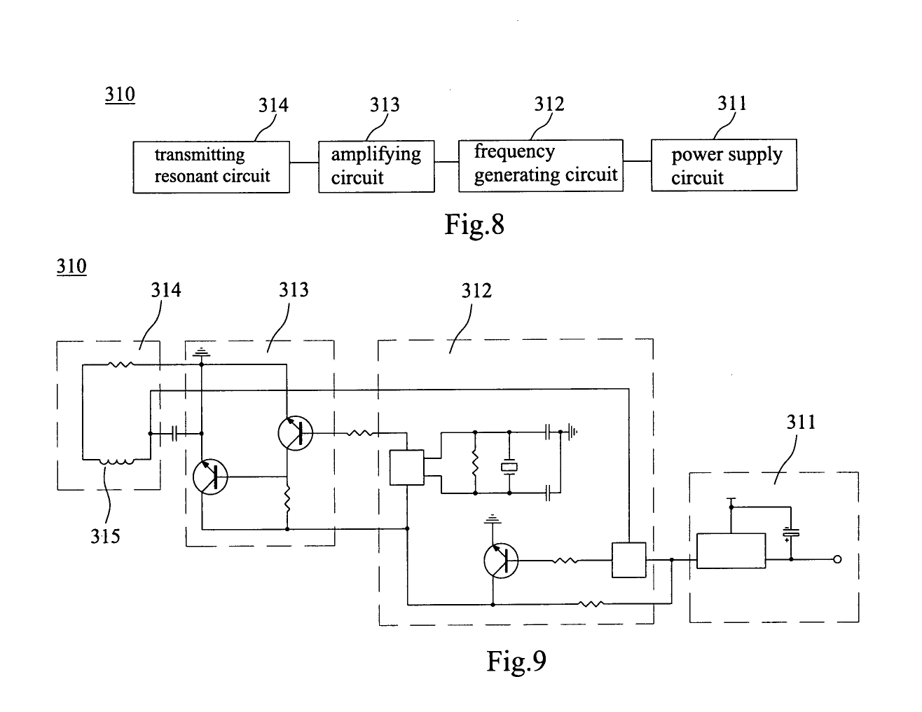

Referring to FIG. 8 and FIG. 9, FIG. 8 is a block diagram showing the transmitter of a wireless charging system according to the first embodiment of the present invention, and FIG. 9 is a detailed circuit of the block diagram of the transmitter shown in FIG. 8. As illustrated, the transmitter 310 includes a power supply circuit 311, a frequency generating circuit 312, an amplifying circuit 313 and a transmitting resonant circuit 314, the power supply circuit 311 serves as supplying power source. The frequency generating circuit 312 is connected to the power supply circuit 311 and used to generate oscillator signals. The amplifying circuit 313 is connected to the frequency generating circuit 312 and serves as receiving and amplifying the oscillator signals of the frequency generating circuit 312, and the transmitting resonant circuit 314 is connected to a transmitting coil 315 to transform the amplified signals into magnetic power and transmit the magnetic power.

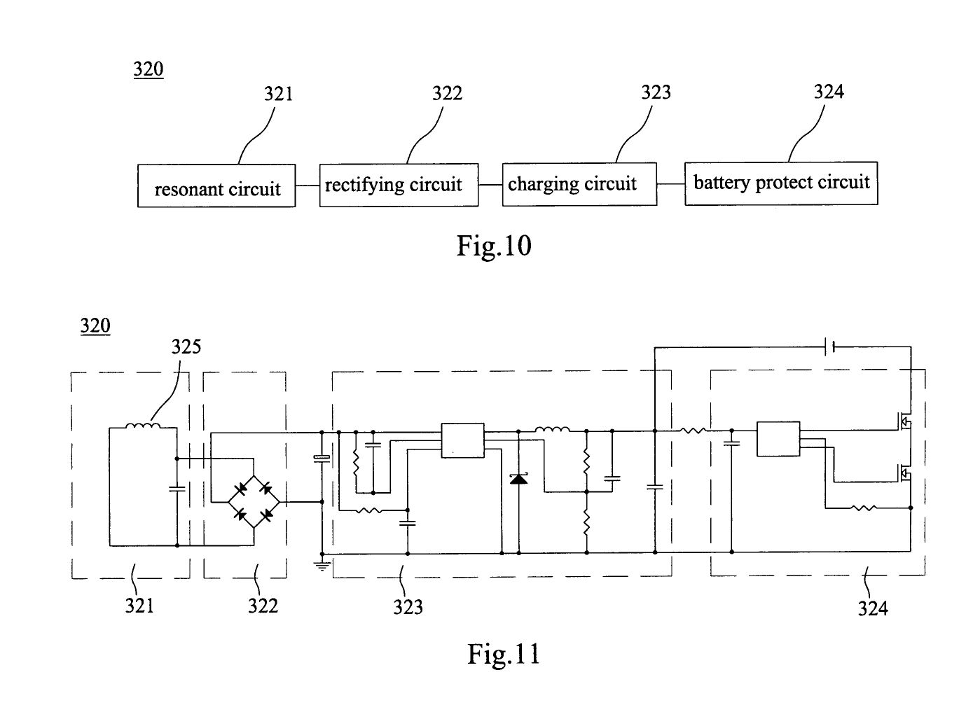

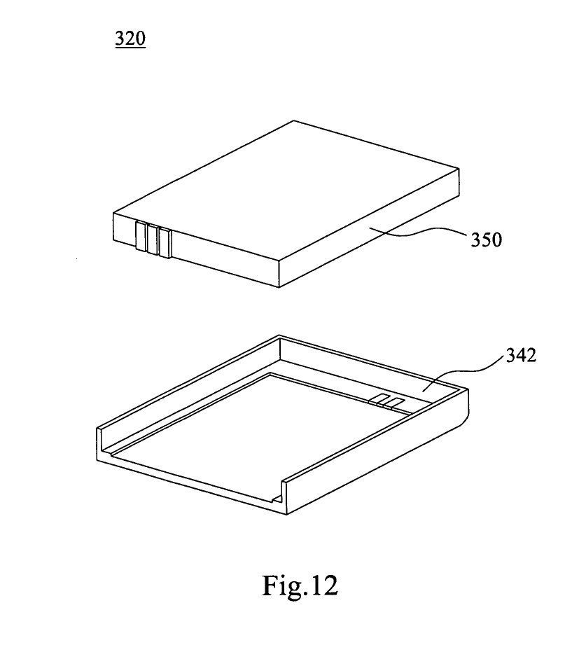

Referring to FIG. 10 and FIG. 11, FIG. 9 is a block diagram showing the electronic device 320 as a receiver of the wireless charging system according to the first embodiment of the present invention, and FIG. 11 is a detailed circuit of the block diagram of the electronic device 320 as a receiver shown in FIG. 10. As illustrated, the electronic device 320 includes a resonant circuit 321, a rectifying circuit 322, a charging circuit 323 and a battery protect circuit 324, the resonant circuit 321 is connected to a receiving coil 325 which is configured to induce the magnetic power transmitted from the transmitting coil 315 of the transmitter to generate inductive current, and then the resonant circuit 321 transform the inductive current into electrical power. The rectifying circuit 322 is connected to resonant circuit 321 to receive and rectify the electrical power transformed from the resonant circuit 321. The charging circuit 323 receives the rectified electrical power to charge the battery in the electronic device 320, and the battery protect circuit 324 is connected to the charging circuit 323 to protect the battery from overcharge and short.

FIG. 12 illustrates an electronic device 320 adapted to a wireless charging system according to an exemplary embodiment of the present invention. The electronic device 320 comprises a housing (not shown) with a main frame and a back cover 342 and a battery 350. The battery 350 is configured to be housed in the housing, that is, the battery 350 is attached to the main frame of the housing and the back cover 342 of the housing is configured to cover the battery 350.

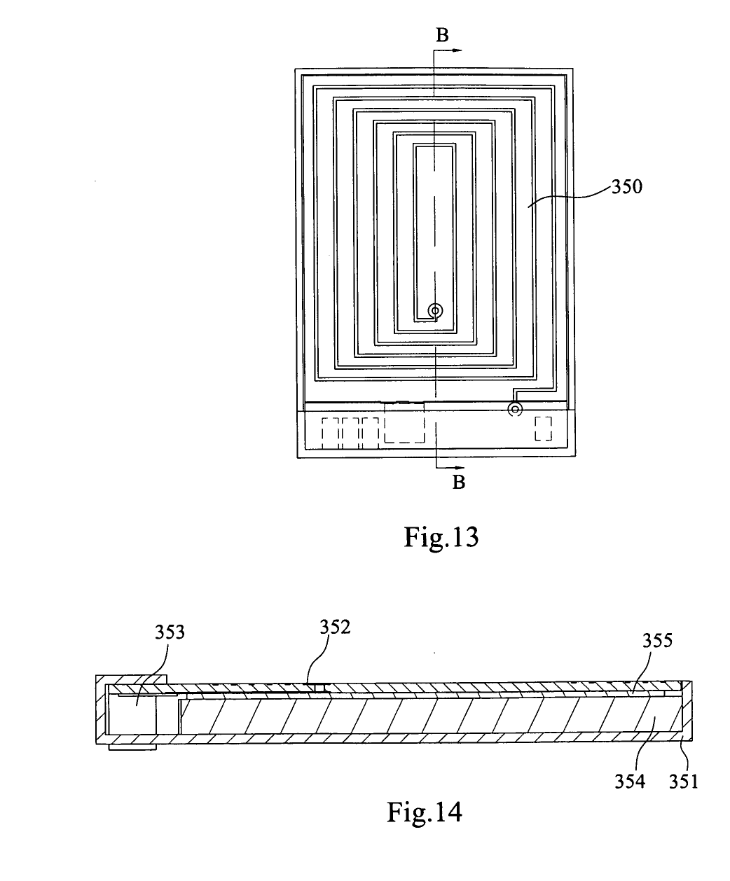

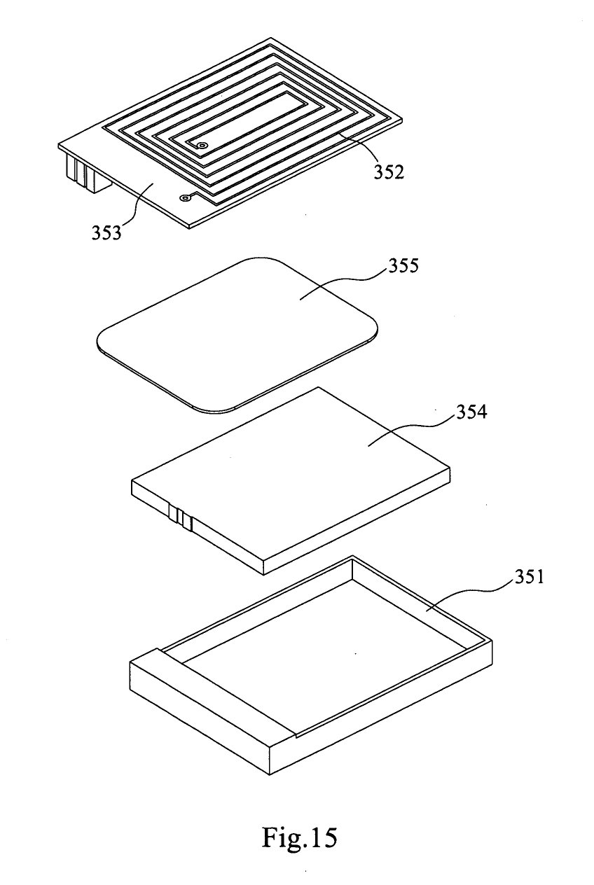

Now referring to FIGS. 13-15, the battery 350 comprises a case 351, a coil 352, a PCB 353, a core 354 and a shield 355. The case 351 is used to enclose the coil 352, the PCB 353, the core 354, and the shield 355 therein. The coil 352 has the function as the receiving coil 325 to induce the magnetic power transmitted from the transmitter 310 of the wireless charging system 300 to generate inductive current. The coil 325 is copper or other metal magnet wire, and the coil 325 could be type of winding or cutting, sharp of round or squared, single or multi-strands with 5-50 turns and size 30 mm*40 mm*(0.2-1) mm. The PCB 353 is electrically connecting the coil 325 to transform the inductive current of the coil 325 into electrical power and protect the battery 350, so all the circuits of the electronic device 320 said above are integrated into the PCB 353 by PCB technology, that is, the PCB 353 is integrated with the resonant circuit 321, the rectifying circuit 322, the charging circuit 323 and the battery protect circuit 324 (referring to FIG. 11). As shown in FIG. 15, the coil 352 can be printed on the PCB 353 by plating, etching or silkscreen process. It will be appreciated that the coil 352 can also be printed on a FPCB by etching or silkscreen process and then connected with the PCB 353. The core 354 is electrically connecting the PCB 353 to store the electrical power for the electronic device 320, and the shield 355 is sandwiched between the coil 352 and the core 354 to protect the core 354 from magnetic power of the transmitter 310 and enhance inductance of the coil 352 as the same. The shield 355 comprises a composite material consisting of ferrites, Mn—Zn, Ni—Fe, or fine metals (Fe—Si—Cu—Nb) to enhance L value of the coil to induce high magnetic power.

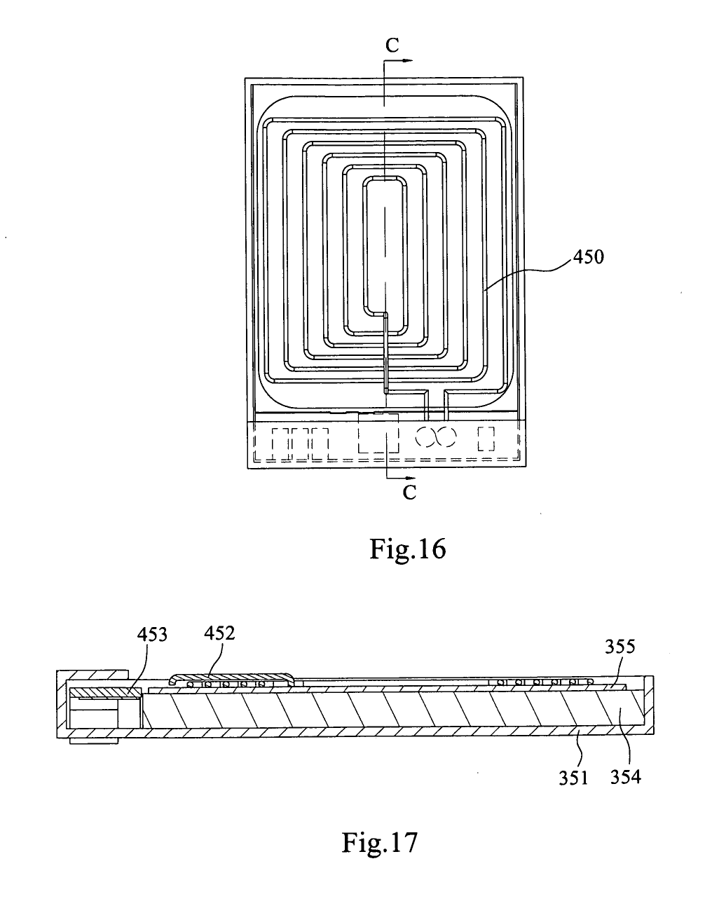

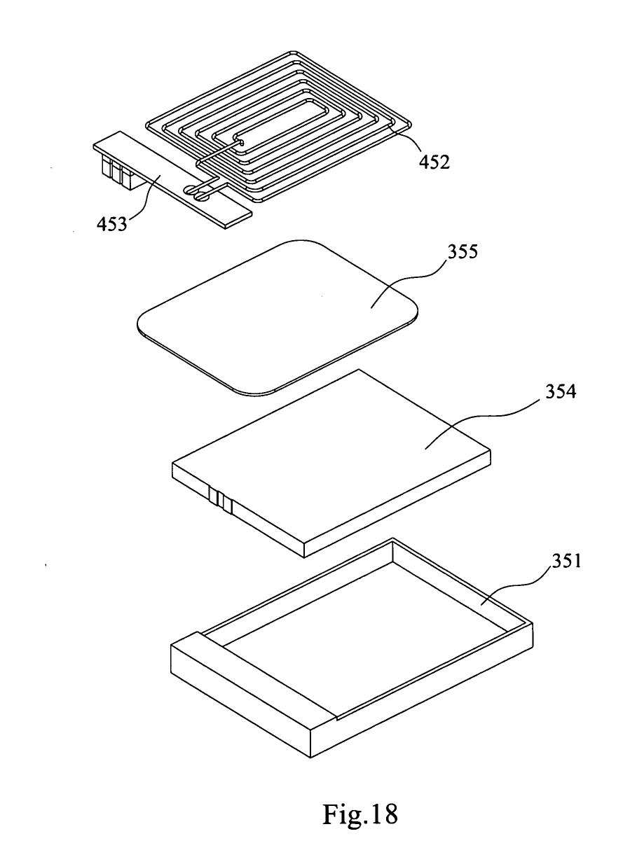

FIGS. 16-18 illustrate a battery 450 according to another embodiment of the present invention which is similar to that shown in FIG. 13. The different is in that the coil 452 in the present embodiment is an independent coil as the structure as the coil 352 and then connected to the PCB 453.

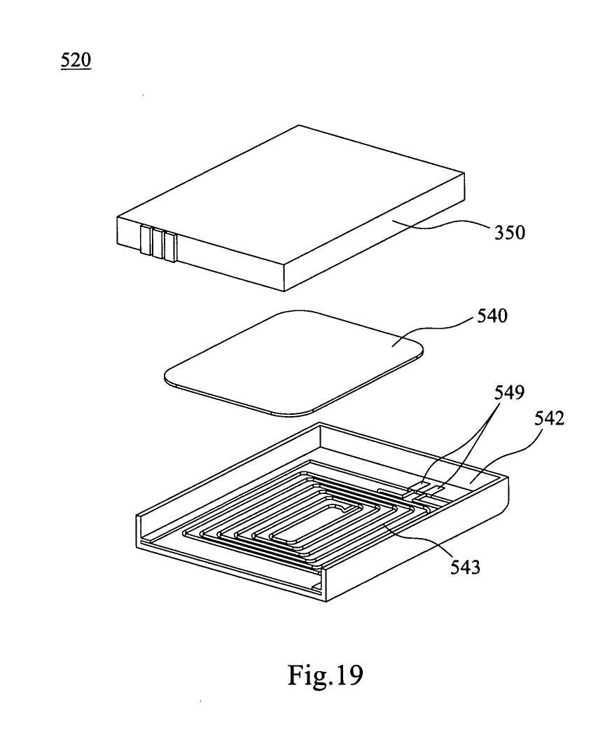

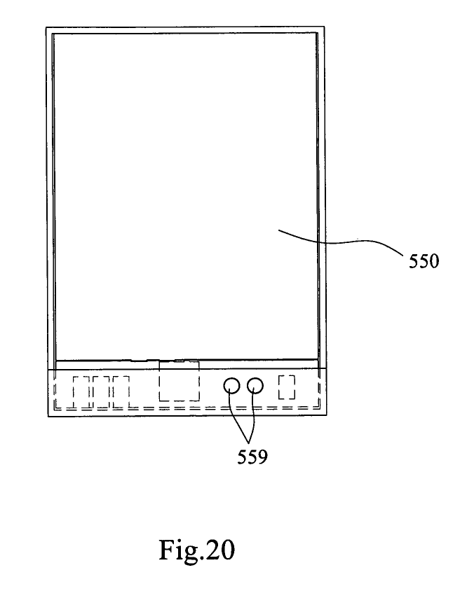

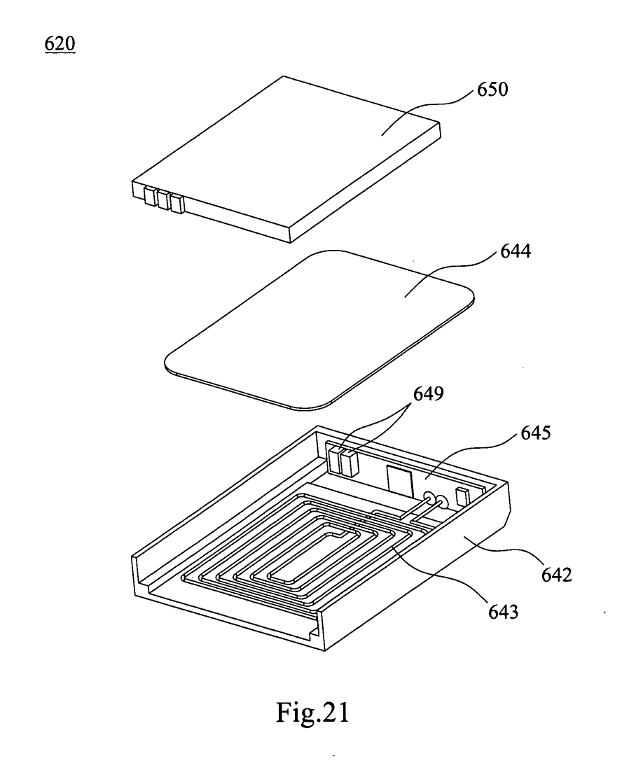

Now referring to FIG. 19, FIG. 19 illustrates an electronic device 520 adapted to a wireless charging system according to a second embodiment of the present invention. The electronic device 520 comprises a housing (not shown) with a main frame and a back cover 542, a coil 543, a shield 544 and a battery 550. The battery 550 is configured to be housed in the housing, that is, the battery 550 is attached to the main frame of the housing, and the back cover 542 of the housing is configured to cover the coil 543, the shield 544 and the battery 550. The coil 543 is configured to induce the magnetic power transmitted from the transmitter of the wireless charging system to generate inductive current for the battery 550. The coil 543 can be printed on the back cover 542 of the housing by plating, etching or silkscreen process. Alternatively, or in addition, the coil 543 could be an independent coil which is over-molded into the back cover 542 of the housing. The shield 544 is sandwiched between the coil 543 and the battery 550 to protect the battery 550 from the magnetic power of the transmitter and enhance inductance of the coil 543. The battery 550 comprises a case, a core and a PCB which are attached to the case. Referring to FIG. 20, the PCB of the battery 550 is electrically connected to the coil 543 by the pins 559 thereon connected to the pads 549 formed on the back cover 542 for electrical connection to the coil 543 to transform the inductive current of the coil 543 into electrical power for the battery 550. The PCB is integrated with a resonant circuit, a rectifying circuit, a charging circuit and a battery protect circuit, all of which are integrated into the PCB by PCB technology with the same function as the circuits of the electronic device 320 said above. The core is electrically connected to the PCB to store the electrical power for the electronic device.

FIG. 21 illustrates an electronic device 620 adapted to a wireless charging system according to a third embodiment of the present invention. The electronic device 620 comprises a housing (not shown) with a main frame and a back cover 642, a coil 643, a shield 644, a PCB 645 and a battery 650. The battery 650 is configured to be attached to the main frame of the housing, and the back cover 642 of the housing is configured to cover the coil 643, the shield 644, the PCB 645 and the battery 650. The coil 643 is configured to induce the magnetic power transmitted from the transmitter of the wireless charging system to generate inductive current for the battery 650. The coil 643 can be printed on the back cover 642 of the housing by plating, etching or silkscreen process. Alternatively, or in addition, the coil 643 could be an independent coil which is over-molded into the back cover 642 of the housing. The shield 644 is sandwiched between the coil 643 and the battery 650 to protect the battery 650 from the magnetic power of the transmitter and enhance inductance of the coil 643. The PCB 645 is situated on the side of the back cover 642 for electrically connecting the coil 643 to transform the inductive current of the coil 643 into electrical power for the battery 650. The PCB is integrated with a resonant circuit, a rectifying circuit, a charging circuit and a battery protect circuit, all of which are integrated into the PCB by PCB technology with the same function as the circuits of the electronic device 320 said above. The battery 650 comprises a case, a core which is attached to the case. And the battery 650 is electrically connected to the coil 643 by the pins (not shown) thereon connected to the pads 649 formed on the PCB 645 for electrical connection to the coil 543 to gain and store the electrical power for the electronic device from the PCB 645.

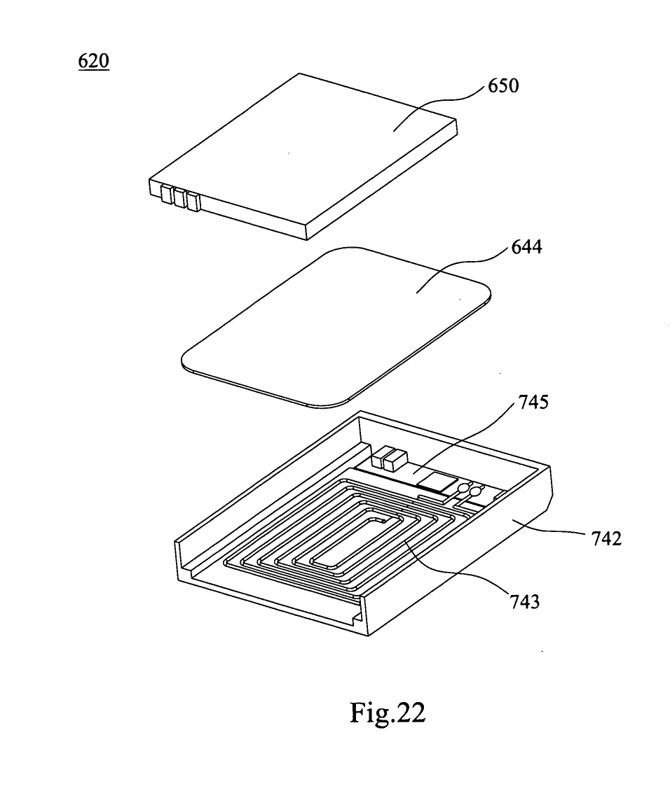

FIG. 22 illustrates an electronic device 720 adapted to a wireless charging system according to the fourth embodiment of the present invention which is similar to that shown in FIG. 21. The different is in that The PCB 745 is located in the front of the back cover 742 for electrically connecting the coil 743 to transform the inductive current of the coil 743 into electrical power for the battery 750.

The foregoing description of the present invention has been presented for purposes of illustration and description. It is not intended to be exhaustive or limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A battery adapted to a wireless charging system, the wireless charging system comprising a transmitter for generating and transmitting magnetic power, the battery comprising:
a coil, configured to induce the magnetic power transmitted from the transmitter of the wireless charging system to generate inductive current;
a PCB, electrically connecting the coil to transform the inductive current of the coil into electrical power;
a core, electrically connecting the PCB to store the electrical power;
a shield, being sandwiched between the coil and the core to protect the core from magnetic power of the transmitter and enhance inductance of the coil; and
a case, configured to enclose the coil, the PCB, the core, and the shield therein.

2. The battery as claimed in claim 1, wherein the coil is printed on the PCB by plating, etching or silkscreen processes.

3. The battery as claimed in claim 1, wherein the coil is printed on a FPCB by etching or silkscreen processes and then connected with the PCB.

4. The battery as claimed in claim 1, wherein the coil is metal magnet wire.

5. The battery as claimed in claim 1, wherein the PCB is integrated with a resonant circuit, a rectifying circuit, a charging circuit and a battery protect circuit, the resonant circuit is connected to the coil to transform the inductive current into electrical power; the rectifying circuit serves as receiving and rectifying the electrical power of the resonant circuit; the charging circuit receives the rectified electrical power to charge the battery; and the battery protect circuit protects the battery from overcharge and short.

6. A wireless charging system, comprising:
a transmitter, configured to generate and transmit magnetic power;
a battery, configured to induce the magnetic power transmitted from the transmitter and store electric power transformed from the magnetic power;
wherein the battery comprising:
a coil, configured to induce the magnetic power transmitted from the transmitter of the wireless charging system to generate inductive current;
a PCB, electrically connecting the coil to transform the inductive current of the coil into electrical power;
a core, electrically connecting the PCB to store the electrical power;
a shield, being sandwiched between the coil and the core to protect the core from magnetic power of the transmitter and enhance inductance of the coil; and
a case, configured to enclose the coil, the PCB, the core, and the shield therein.

7. The wireless charging system as claimed in claim 6, the transmitter includes a power supply circuit, a frequency generating circuit, an amplifying circuit and a transmitting resonant circuit, the power supply circuit serves as supplying power source; the frequency generating circuit is used to generate oscillator signals; the amplifying circuit serves as receiving and amplifying the oscillator signals of the frequency generating circuit; and the transmitting resonant circuit is connected to a transmitting coil to transform the amplified signals into magnetic power and transmit the magnetic power.

8. The wireless charging system as claimed in claim 6, wherein the PCB is integrated with a resonant circuit, a rectifying circuit, a charging circuit and a battery protect circuit, the resonant circuit is connected to the coil to transform the inductive current into electrical power; the rectifying circuit serves as receiving and rectifying the electrical power of the resonant circuit; the charging circuit receives the rectified electrical power to charge the battery; and the battery protect circuit protects the battery from overcharge and short.

9. The wireless charging system as claimed in claim 6, wherein the coil is printed on the PCB by plating, etching or silkscreen process.

10. The wireless charging system as claimed in claim 6, wherein the coil is printed on a FPCB by etching or silkscreen process and then connected with the PCB.

11. The wireless charging system as claimed in claim 6, wherein the coil is metal magnet wire.

12. An electronic device adapted to a wireless charging system, the wireless charging system comprising a transmitter for generating and transmitting magnetic power, the electronic device comprising a housing and a battery configured to be housed in the housing, wherein the battery comprising:
a coil, configured to induce the magnetic power transmitted from the transmitter of the wireless charging system to generate inductive current;
a PCB, electrically connecting the coil to transform the inductive current of the coil into electrical power;
a core, electrically connecting the PCB to store the electrical power;
a shield, being sandwiched between the coil and the core to protect the core from magnetic power of the transmitter and enhance inductance of the coil; and
a case, configured to enclose the coil, the PCB, the core, and the shield therein.

13. The electronic device as claimed in claim 12, wherein the coil is printed on the PCB by plating, etching or silkscreen process.

14. The electronic device as claimed in claim 12, wherein the coil is printed on a FPCB by etching or silkscreen process and then connected with the PCB.

15. The electronic device as claimed in claim 12, wherein the coil is metal magnet wire.

16. The electronic device as claimed in claim 12, wherein the PCB is integrated with a resonant circuit, a rectifying circuit, a charging circuit and a battery protect circuit, the resonant circuit is connected to the coil to transform the inductive current into electrical power; the rectifying circuit serves as receiving and rectifying the electrical power of the resonant circuit; the charging circuit receives the rectified electrical power to charge the battery; and the battery protect circuit protects the battery from overcharge and short.

17. An electronic device adapted to a wireless charging system, the wireless charging system comprising a transmitter for generating and transmitting magnetic power, the electronic device comprising housing and a battery configured to be housed in the housing, wherein the electronic device further comprises a coil and a shield configured to be housed in the housing, the coil is configured to induce the magnetic power transmitted from the transmitter of the wireless charging system to generate inductive current for the battery, and the shield is sandwiched between the coil and the battery to protect the battery from the magnetic power of the transmitter and enhance inductance of the coil.

18. The electronic device as claimed in claim 17, wherein the housing comprises a main frame and a back cover, the battery is attached to the main frame and the back cover is configured to cover the battery.

19. The electronic device as claimed in claim 18, wherein the coil is printed on the back cover by plating, etching or silkscreen process.

20. The electronic device as claimed in claim 18, wherein the coil as an independent coil which is over-molded into the back cover.

21. The electronic device as claimed in claim 17, wherein the battery comprises a case, a core and a PCB which are attached to the battery case, the PCB is electrically connected to the coil to transform the inductive current of the coil into electrical power for the battery; and the core is electrically connected to the PCB to store the electrical power.

22. The electronic device as claimed in claim 18, further comprising a PCB situated in the front or on the side of the back cover for electrically connecting the coil to transform the inductive current of the coil into electrical power for the battery.
